(19) United States
(12) Patent Application Publication
(10) Pub. No.: US 2025/0214271 A1
(43) Pub. Date: Jul. 3, 2025

(54) AN ASSEMBLY FOR GUIDING A FOOD PRODUCT IN A FOOD PORTIONING MACHINE

(71) Applicant: THURNE-MIDDLEBY LTD, Norwich Norfolk (GB)

(72) Inventors: James WAKEFIELD, Norwich Norfolk (GB); Alastair FEARNS, Norwich Norfolk (GB); Anthony HAREWOOD, Norwich Norfolk (GB); Jacob WIGGETT, Norwich Norfolk (GB); Richard SEAGER, Norwich Norfolk (GB)

(21) Appl. No.: 18/850,318

(22) PCT Filed: Apr. 12, 2023
(86) PCT No.: PCT/GB2023/050979

§ 371 Date: Sep. 24, 2024

(30) Foreign Application Priority Data
Apr. 13, 2022 (GB) 2205489.4
Jan. 13, 2023 (GB) 2300514.3

(51) Int. Cl. B26D 7/06

(52) U.S. Cl. CPC B26D 7/06

(57) ABSTRACT

A product control assembly (2) to guide a food product along a flow path (A) towards a cutter (88) of a food portioning machine and a method of restraining a food product moving towards a cutter. The assembly comprises a pair of side guides (6, 8) for engaging opposite side surfaces of a food product lying on the support plane (84), and a positioning mechanism (10) which is operable to move the side guides towards and away from the support plane, and to change the spacing between the side guides in a transverse direction with respect to the flow path.

### FIELD OF THE DISCLOSURE

The present disclosure relates to an assembly for guiding a food product travelling along a flow path through a food portioning machine.

### BACKGROUND TO THE DISCLOSURE

It is known to feed food products such as bacon, cheese or cooked meat towards a cutting region in a food portioning machine using product drivers such as belt conveyors, tracks or rear end grippers. The food product, which may be in the form of an elongate loaf, log or block for example, is fed incrementally towards the cutting region, where slices or portions of a desired size are cut from a leading end of the food product.

In order to optimise their throughput, it is desirable for such machines to operate at high speed, whilst at the same time providing close control of the weight of the slices or portions outputted by the machine. In order to achieve this close control, it is important to be able to reliably constrain a food product as it approaches and travels past a cutter in the cutting region.

### SUMMARY OF THE DISCLOSURE

The present disclosure provides a control assembly for guiding a food product along a flow path towards a cutter of a food portioning machine when the food product is supported on a support plane defined by the machine, comprising:
an assembly support for mounting on the food portioning machine;
a pair of side guides carried by the assembly support for engaging opposite side surfaces of a food product lying on the support plane; and
a positioning mechanism which is carried by the assembly support and is operable:
to move the side guides relative to the assembly support towards and away from the support plane; and
to change the spacing between the side guides in a transverse direction with respect to the flow path.

The control assembly is operable to move the side guides into desired positions so as to constrain an adjacent food product as it is carried past the control assembly along the flow path. The pair of side guides may engage side surfaces located on opposite sides of the underside of a food product arranged with its underside resting on the support plane. A food product supported on a support plane defined by the machine may be constrained laterally, or both laterally and vertically relative to the support plane by the control assembly.

The location and orientation of a food product may be closely controlled by the control assembly as it approaches a cutter of the food portioning machine, as it moves through the cutting plane between cuts, and also during each cut. This ensures that the location of each cut on the food product can be precisely controlled. This in turn provides accurate control of the size of each portion cut from the food product.

The application of constraining forces to a food product as it approaches the cutting region of a food portioning machine may also be desirable to minimise any change in the shape of the food product as it travels towards the cutter. In some food processing systems, notably when handling irregular food products, the shape of the food product may be detected upstream of the cutter and used by the system to determine the thickness of each portion to be cut. It is then beneficial to minimise any change in the shape of the food product between detection of its external profile and the cutting process.

Some food processing systems may include processing stages upstream of the cutting region which involve application of forces to the food product to alter its shape and/or cooling of the food product to freeze at least an outer layer of the food product and thereby increase its rigidity. In such a system, the present control assembly may be used to minimise any relaxation or other changes in the shape of such a food product as it travels towards the cutting region.

The control assembly may include one or more drives for driving the positioning mechanism. Alternatively, the positioning mechanism may be driven using one or more drives located elsewhere in the food portioning machine.

Two drives may be shared by the side guides such that both drives are operable to change the position of both side guides. This may provide more even control of the motion of the side guides and the forces they exert, in comparison to using separate drives for each side guide.

Upper portions of the pair of side guides may be coupled to the positioning mechanism, with each side guide extending from their upper portion in a direction towards the support plane to lower distal ends. Each side guide may be elongated in the direction of the flow path.

The side guides may include inwardly facing side surfaces for engaging opposite side surfaces of a food product. Each side guide may also include a surface which extends laterally inwardly relative to the respective side surface for engaging with a top surface of a food product.

A lower portion of each inwardly facing side surface may be substantially planar. An upper portion of each inwardly facing side surface may define a curve extending smoothly inwardly from a planar lower portion in transverse cross-section.

The positioning mechanism may be operable to selectively and/or simultaneously (a) move the side guides relative to the assembly support towards and away from the support plane and (b) change the spacing between the side guides in a transverse direction with respect to the flow path.

The side guides may be carried by the positioning mechanism. In preferred examples, the positioning mechanism is operable to move each side guide towards and away from the other, preferably moving each side guide at the same speed relative to the assembly support. Thus, the motion of the side guides may be symmetrical relative to a reference plane located midway between the side guides and at a fixed location relative to the assembly support.

In some implementations, the positioning mechanism includes a first drive belt which is coupled to the side guides to move them relative to the assembly support. Use of a common drive belt in this manner may ensure reliable coordination of their respective motions. Preferably, the positioning mechanism is arranged with each side guide rigidly coupled to the first drive belt at a respective fixed location on the drive belt.

The first drive belt may be driven by two drive motors which are mounted at fixed locations on the assembly support. The drive belt may extend around a series of wheels or pulleys.

The first drive belt may include first and second sections which extend parallel to each other, with each section having a respective side guide rigidly coupled to it. The mechanism may be operable to drive the first drive belt such that the first and second sections carry out equal motions in opposite directions parallel to their lengths, causing the side guides to execute corresponding motions and so be movable towards and away from each other.

The positioning mechanism may include a second drive belt which extends around a path lying in a second plane which is parallel to and spaced from a first plane which includes the path followed by the first drive belt. The second drive belt may be coupled to the side guides in a similar manner to the first drive belt. The positioning mechanism may thus be coupled to the side guides at two locations which are spaced apart in the direction of the flow path, so as to control the position and motion of elongate side guides more reliably. Drive shafts may be used to transmit motion of the first drive belt to the second drive belt so that it is replicated by the second drive belt. The positioning mechanism may include only two drive motors, which operate to drive both the first and second drive belts.

Drive belts and pulleys are suitable for use in a food handling environment, where cleanliness and robustness are needed. This is particularly significant given the intended location of the present product control assembly over the flow path of the food products. Such mechanisms may be used to reduce the number of components and drives needed to control the position of the side guides in two orthogonal dimensions. This in turn leads to greater reliability of the mechanism and more precise control.

In a preferred example, the positioning mechanism has an “H bot” configuration. It is able to provide the desired motions whilst only requiring a limited number of components.

Nevertheless, it will be appreciated that other movement generating structures may be used to move the side guides relative to the assembly support and to change the spacing between the side guides. Such structures may for example use linear actuators, ball screws, pistons, drive belts, pulleys, and/or dedicated motors for moving the side guides towards and away from the support plane and moving the side guides towards and away from each other, respectively. One of ordinary skill in the art would readily comprehend how to construct suitable structures with the desired functionality having regard to the present specification without undue experimentation.

In some implementations, the control assembly includes a top guide for engaging an upper surface of a food product. The positioning mechanism may be operable to move the top guide relative to the assembly support towards and away from the support plane. The top guide may be moved by the positioning mechanism relative to the assembly support towards and away from the support plane together with the side guides. Each side guide may extend away from the top guide in a direction towards the support plane. The side guides may be arranged to move over the underside of the top guide. Each side guide may be adjacent to the underside of the top guide.

The positioning mechanism may be arranged to move the side guides along a first transverse direction which is transverse with respect to the flow path. The side guides may also be moved by the positioning mechanism (together with the top guide when present) along a second transverse direction which may be orthogonal to the first transverse direction.

Preferably, the positioning mechanism is operable to adjust a control force exerted on a food product by the side guides and/or the top guide of the assembly.

For example, the positioning mechanism may be operable to adjust the control force so that the control force exerted when the food product is moving towards a cutter of the food portioning machine is lower than the control force exerted during cutting of the food product. More particularly, the positioning mechanism may be operable to adjust the control force so that a maximum control force that can be exerted when the food product is moving towards a cutter of the food portioning machine is lower than a maximum control force that can be exerted during cutting of the food product. The control force may (or may not) be reduced between each cut as a food product is moved forwards in preparation for the next cut.

Accordingly, the control assembly may be arranged to sufficiently constrain the food product as it moves forward to maintain positional control without unduly restricting the movement of the food product along the flow path. A greater level of restraint may then be applied during cutting to minimise any movement of the food product during the cutting process, thereby increasing the accuracy of the cut.

In preferred implementations, the torque generated by the drives used to move the side guides and/or the top guide may be adjustable to vary the control force. The drives may be servo motors, for example. The drives may be selectively operable in a “position mode” and a “position and torque mode”. In position mode, the drives operate to move a guide to a predetermined position. In position and torque mode, the drives operated to drive a guide towards a predetermined position, stopping short of the predetermined position if a predetermined torque threshold is reached.

Position mode may be more suitable for softer food products which will yield more as pressure is applied. Position and torque mode may be preferable for harder food products which are less pliant.

The present disclosure also provides a food portioning machine including a control assembly for guiding a food product as described herein. The food portioning machine may include a conveying system for carrying a food product along a flow path past the control assembly. The support plane of the machine may be defined by a product support surface of the conveying system.

The food portioning machine may include controller for controlling operation of the machine, wherein the controller is able to generate control signals which govern the maximum control force exerted on a food product by the side guides and/or the top guide of the assembly.

The control assembly may be arranged to engage a food product when the food product is at a position adjacent to a cutter of the machine.

The machine may include a sensing region in which the shape of the food product is detected and a cutter for cutting the food product into portions, wherein the control assembly is arranged to guide a food product received directly from the sensing region towards and directly to the cutter. Thus, the control assembly may be arranged to receive the food product directly as it leaves the sensing region and to guide the food product all the way from the sensing region to the cutter. The control assembly may be able to control the location of the food product laterally as it is carried by the conveying system of the food portioning machine and travels along the flow path past the control assembly from the sensing region to the cutter.

The present disclosure further provides a method of guiding a food product along a flow path towards a cutter of a food portioning machine when the food product is supported on a support plane defined by the machine using a control assembly as described herein, the method comprising the step of bringing the pair of side guides into engagement with opposite side surfaces of the food product lying on the support plane using the positioning mechanism.

In a preferred example, the method includes the steps of:
exerting a movement control force on the food product with the side guides as the food product moves along the flow path; and
exerting a cutting control force on the food product with the side guides during cutting of the food product, with the cutting control force being greater than the movement control force.

In addition, the present disclosure provides a method of restraining a food product moving along a flow path towards a cutter of a food portioning machine, comprising the steps of:
exerting a movement control force on the food product as the food product moves along the flow path; and
exerting a cutting control force on the food product during cutting of the food product, with the cutting control force being greater than the movement control force.

In some implementations, the movement control force may be less than or equal to a movement control force threshold, and the cutting control force may be less than or equal to a cutting control force threshold, with the cutting control force threshold being greater than the movement control force threshold.

The movement control force may be exerted on the food product as it moves along the flow path towards the cutter. Once the food product has moved past the cutter ready for the first cut to be made, the cutting control force may then be applied.

The movement control force may be exerted on the food product between each cut through the food product, as the food product moves along the flow path in preparation for the next cut.

The cutting control force may be exerted at least at the start of each cut through the food product. After each cut has been started (or after completion of each cut), the magnitude of the control force exerted on the food product may be reduced to facilitate subsequent movement of the food product along the flow path past the control assembly, before the next cut is started.

In some cases, it may be preferable for the cutting control force to be maintained throughout the cutting process, without reducing it between cuts. For example, this may be desirable when portioning at very high speeds (such as 600 portions per minute) when there may be insufficient time between cuts for the control force to be reduced and then increased again. The cutting control force may be adjusted to a level which provides enough force to control the position of the food product during cutting, whilst also allowing the food product to be moved forward sufficiently freely in preparation for the next cut.

In preferred implementations, a guide which exerts the movement control force is also used to exert the cutting control force on the food product. The guide may exert the control forces on the food product by contacting the food product whilst it is carried by a conveying system of the food portioning machine.

Preferably, the guide is used to exert the movement control force on the food product as it travels towards the cutter of the food portioning machine before a first cut has been carried out on the food product by the cutter. The guide may exert the control forces on the food product as it travels towards the cutter and then during the cutting process.

The guide may comprise a pair of side guides for engaging opposite sides of a food product lying on a support plane defined by the food portioning machine. The guide may also include a top guide for engaging an upper surface of a food product.

The magnitude of the force exerted by the guide may be controlled by adjusting a pushing force exerted on the guide which urges the guide towards the food product. A mechanism used to generate the pushing force may be controlled such that the movement control force does not exceed a predetermined movement control force threshold and the cutting control force does not exceed a predetermined cutting control force threshold.

### BRIEF DESCRIPTION OF THE DRAWINGS

Examples of the present disclosure will now be described with reference to the accompanying schematic drawings, wherein:

FIG. 1 is a front view of an assembly according to an example of the present disclosure in two different configurations;

FIGS. 2 and 3 are front views of selected components of an assembly according to an example of the present disclosure to illustrate operation of the assembly;

FIG. 4 is a perspective view of an assembly according to an example of the present disclosure, together with a cutter and conveyor of a food portioning machine;

FIG. 5 shows the assembly of FIG. 4 in combination with a pusher; and

FIGS. 6 and 7 are perspective views of the pusher included in FIG. 5.

### DETAILED DESCRIPTION

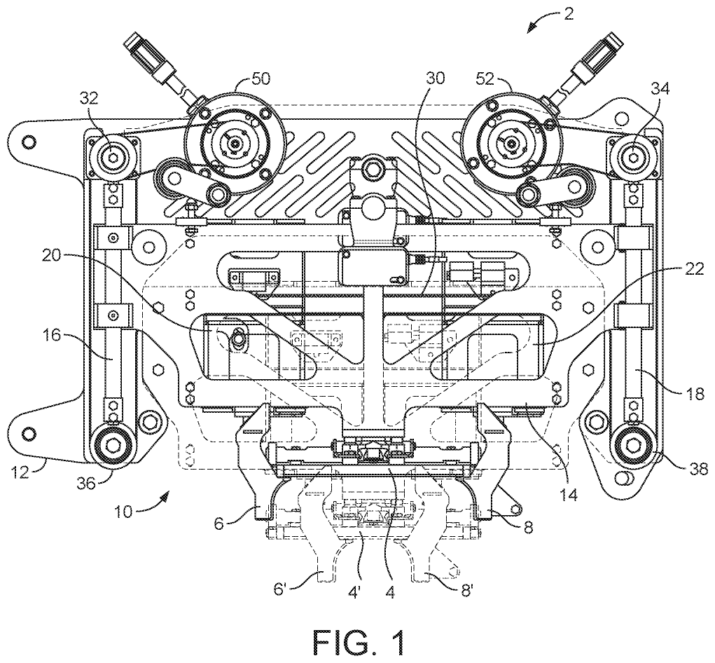

The product control assembly 2 shown by way of example in FIG. 1 includes a top guide 4 and a pair of side guides 6, 8. The top and side guides are carried by a positioning mechanism 10 which is carried by an assembly support in the form of a supporting framework 12. In a food portioning machine, the supporting framework 12 is rigidly mounted onto a support or a housing which forms part of the food portioning machine.

The positioning mechanism includes a main body 14 which is coupled to the supporting framework in such a way that it is able to move linearly relative to the supporting framework. In the example of FIG. 1, the main body is slidably coupled to a pair of elongate parallel guide members 16, 18 which form part of the supporting framework. The top guide 4 is rigidly coupled to the main body.

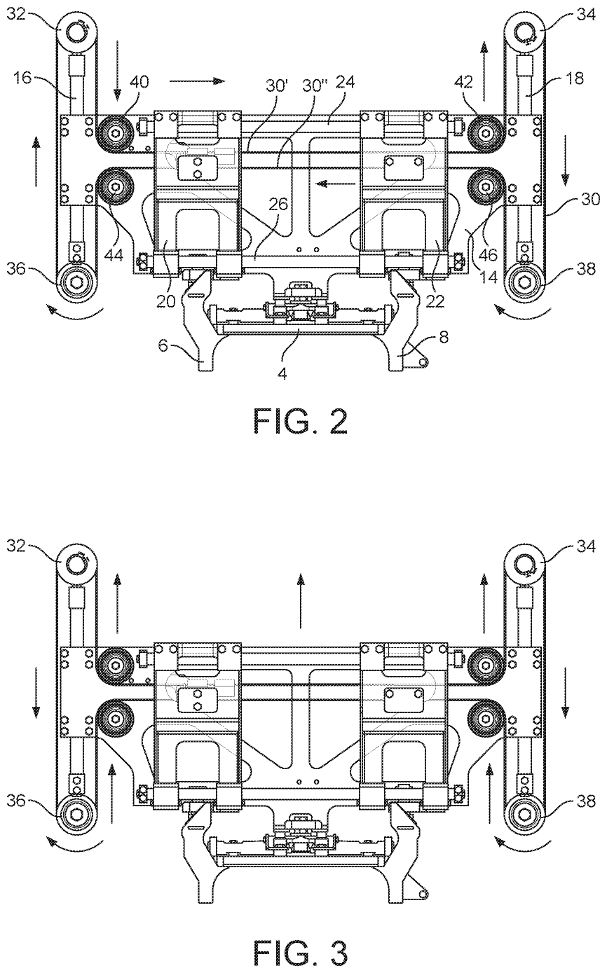

Each side guide 6,8 is rigidly coupled to a respective guide support 20, 22. Each guide support is coupled to the main body 14 in such a way that is it is able to move linearly relative to the main body, along a direction orthogonal to the linear motion of the main body relative to the supporting framework. The guide supports may be slidably coupled to a pair of elongate parallel guide members 24, 26 (visible in the example of FIGS. 2 and 3) which are rigidly mounted onto the main body.

Preferably, each side guide is profiled on its surface facing the opposite side guide such that it curves inwardly in the vertical direction. This may enable the side guides to conform more closely to the shape of a food product and thereby more closely constrain its cross-sectional shape as it passes beneath the assembly.

The positioning mechanism is shown in two different configurations in FIG. 1. The first is shown using solid lines and the second using dashed lines. In the first configuration, the positioning mechanism is arranged such that the top guide 4 is located at one end of its range of motion relative to the supporting framework where it is closest to the supporting framework. In the second configuration, the positioning mechanism is arranged such that the top guide is located at the opposite end of its range of motion relative to the supporting framework, where it is furthest from the supporting framework (this position is denoted 4′ in FIG. 1).

Similarly, in the first configuration, the positioning mechanism is arranged such that the side guides 6, 8 are located with a maximum spacing between them. In the second configuration, the positioning mechanism is arranged such that the side guides are located with a minimum spacing (these locations are denoted 6′, 8′ in FIG. 1).

The positioning mechanism is operable to independently (i) move the top and side guides relative to the supporting framework and (ii) move the side guides relative to the top guide.

Further features of the positioning mechanism will now be described with reference to FIGS. 2 and 3. The mechanism includes a single, continuous drive belt 30. The drive belt extends around four pulleys 32, 34, 36 and 38 and four guide wheels 40, 42, 44 and 46. The four pulleys and four guide wheels have axes of rotation which are orientated parallel to each other. The pulleys 32 and 36 are located adjacent to the upper and lower ends, respectively, of the guide member 16, whilst the pulleys 34 and 38 are located adjacent to the upper and lower ends, respectively of the guide member 18. Each of the pulleys is rotatably coupled to the supporting framework at a respective fixed location. The four guide wheels are located inwardly of the pulleys, in both vertical and horizontal directions.

The pulleys and guide wheels are located such that the drive belt is able to run in a vertical direction to and from each pulley and in a horizontal direction between guide wheels 40 and 42 and between guide wheels 44 and 46. This may be referred to as an “H bot” configuration as the path of the belt forms an H-shape.

The guide support 20 is rigidly coupled to an upper strand 30′ of the drive belt, whilst guide support 22 is rigidly coupled to a lower strand 30″ of the drive belt.

FIGS. 2 and 3 are marked with arrows indicating directions of motion of the drive belt in two different modes of operation of the positioning mechanism. In the mode shown in FIG. 2, all four of the pulleys are rotating in the same direction about their axes of rotation. This causes the upper and lower strands 30′, 30″ of the drive belt to move in opposite directions. When the pulleys are rotated in a clockwise direction (when viewed in FIG. 2) this causes the guide supports 20, 22 (and therefore the side guides 6, 8) to move towards each other. Conversely, when the pulleys are rotated in an anticlockwise direction, this causes the guide supports (and therefore the side guides 6, 8) to move further apart.

In the mode shown in FIG. 3, pulleys 32 and 36 are rotating in an anticlockwise direction, whilst pulleys 34 and 38 are rotated clockwise. This causes the belt to lift the main body 14 (and therefore the top guide 4 and side guides 6, 8) vertically along guide members 16, 18. The upper and lower strands 30′ and 30″ of the drive belt do not move relative to each other in this mode and so the spacing of the side guides 6,8 is unchanged. Alternatively, when pulleys 32 and 36 are rotated in a clockwise direction whilst pulleys 34 and 38 are rotated anticlockwise, the belt lowers the main body 14 (and therefore the top guide 4 and side guides 6, 8) relative to the supporting framework along the guide members 16, 18.

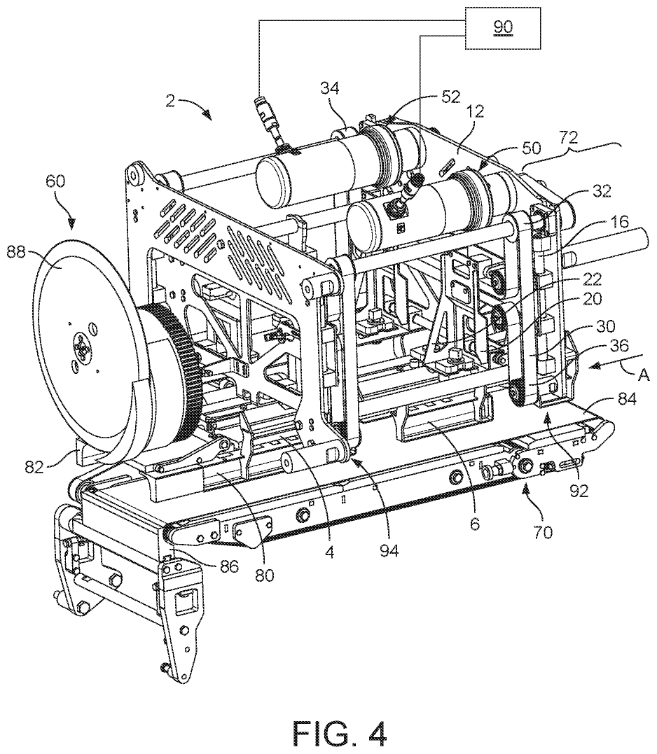

First and second drive motors 50, 52 (shown in FIGS. 1 and 4) are mounted on the supporting framework 12. The first drive motor 50 is coupled to pulley 32 so as to be able to drive rotation of this pulley, whilst the second drive motor 52 is similarly coupled to pulley 34. The drive motors may be servomotors for example.

The drive motors 50, 52 are communicatively coupled to a controller 90 of the food portioning machine (see FIG. 4).

If only one of pulleys 32 and 34 is rotated by the corresponding motor, the main body is caused to move relative to the supporting framework at the same time as the guide supports are caused to move relative to the main body. By driving the pulleys 32 and 34 simultaneously at different speeds, the speed of the motion of the main body relative to the supporting framework may be controlled independently of the speed of the simultaneous motion of the guide supports relative to the main body.

FIG. 4 shows an example of an assembly as described herein in combination with a cutting mechanism 60 and a conveyor 70 of a food portioning machine. During operation of the machine, food products travel along a flow path A from a sensing region 72 onto the conveyor 70. The flow path extends below the assembly 2 and the cutting mechanism. As food products pass beneath the assembly and past the cutting mechanism, their position and orientation on the conveyor is controlled by the assembly.

The sensing region 72 comprises one or more sensors (not shown) for sensing the shape of the food product. For example, the sensors may detect an outer contour or profile of the food product as it moves past the sensors. Output signals from the sensors may then be used to determine the shape of the exterior of the food product. As a leading end of a food product leaves the sensing region, it is received directly by the product control assembly 2.

The top guide 4 is elongated along a longitudinal axis which is parallel to the flow path A. In this example, the positioning mechanism carries two pairs of side guides, namely a first pair 6,8 and a second pair 80, 82 which is located downstream of the first pair. In order to carry opposite ends of the top guide and the second pair of side guides, the assembly shown in FIG. 4 includes a second, downstream H bot mechanism 94 which is also carried by the supporting framework and driven by the drive motors 50, 52 to carry out the same motions as the upstream H bot mechanism 92.

The conveyor 70 includes a conveyor belt 84, the upper surface of which defines a support plane of the food portioning machine. A cutting edge 86 is provided adjacent to the downstream end of the conveyor belt.

The cutting mechanism includes a cutter in the form of a circular blade 88 which is mounted for orbital motion so that it interacts with the cutting edge 86 to cut portions from the leading end of a food product which extends beyond the cutting edge.

The controller 90 is able to generate control signals for the first and second drive motors 50, 52. The control signals may instruct the drive motors to move the top and side guides to specific positions. The control signals may also dictate the maximum control force to be exerted on a food product by the side guides and/or the top guide of the assembly. The control signals may be generated with reference to data related to the external profile (and potentially other physical properties) of an individual food product (or a group of products) that is to be controlled using the control assembly.

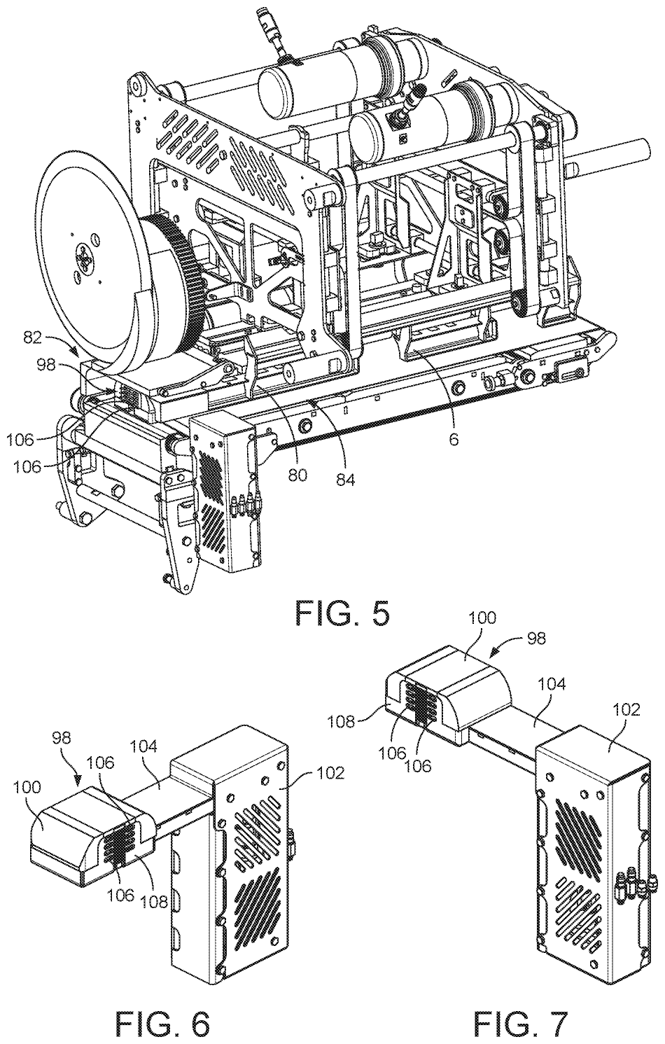

The food portioning machine may also include a pusher 98 which engages with a trailing end of a food product in order to push it towards the cutting region. A pusher not shown in FIG. 4, but is included in FIG. 5. The pusher 98 is shown separately in FIGS. 6 and 7. It comprises a pusher head 100 which is rigidly coupled to a pusher support 102 via an arm 104. The pusher support is carried by a supporting framework of the food portioning machine via a drive mechanism (not shown in the Figures) arranged to reciprocate the pusher support relative to the supporting framework along a direction parallel to the flow path A.

The pusher provides support for the trailing end, which becomes particularly beneficial as the amount of the food product remaining to be portioned reduces. The pusher operates in combination with the control assembly 2 and the conveyor 70 to ensure reliable control of the location of the food product during cutting, thereby enabling the machine to maintain accurate control of the location of each cut. The pusher, together with the conveyor belt 84, indexes the food product past the cutting edge 86 between each cut. The biasing force exerted on the food product by the product control assembly may be reduced or removed between each cut.

The pusher 98 shown in FIGS. 5 to 7 includes teeth 106 for firmly gripping the trailing end of a food product. The teeth are movable between extended positions and retracted positions. The teeth are shown in their extended positions in FIG. 5 and are retracted in FIGS. 6 and 7. The pusher includes a product engaging surface 108. The teeth extend beyond surface 108 in their extended positions and lie behind the surface in their retracted positions.

The present control assembly may facilitate use of a pusher without teeth, which does not therefore pierce or damage the trailing end. Due to enhanced constraint of the food product provided by the control assembly, the pusher may not need to provide a gripping action, but merely be required to push against the trailing end. As a result, a final portion of a food product at its trailing end may be a more valuable, better quality portion.

The pusher is transversely retractable from the food path once cutting of a food product has been completed, to enable the pusher to be moved upstream and then reinserted in the flow path and engaged with the trailing end of the next food product to be portioned.

The following enumerated paragraphs represent illustrative, non-exclusive ways of describing examples according to the present disclosure.
A. A control assembly for guiding a food product along a flow path towards a cutter of a food portioning machine when the food product is supported on a support plane defined by the machine, comprising:
   an assembly support for mounting on the food portioning machine;
   a pair of side guides carried by the assembly support for engaging opposite side surfaces of a food product lying on the support plane; and
   a positioning mechanism which is carried by the assembly support and is operable:
   to move the side guides relative to the assembly support towards and away from the support plane; and
   to change the spacing between the side guides in a transverse direction with respect to the flow path.
A1. An assembly of paragraph A, wherein the positioning mechanism is operable to selectively and/or simultaneously (a) move the side guides relative to the assembly support towards and away from the support plane and (b) change the spacing between the side guides in a transverse direction with respect to the flow path.
A2. An assembly of paragraph A, wherein the positioning mechanism is operable to move each side guide towards and away from the other at the same speed relative to the assembly support.
A3. An assembly of any paragraph A, wherein the positioning mechanism includes a drive belt which is coupled to the side guides to move them relative to the assembly support.
A4. An assembly of paragraph A3, wherein each side guide is rigidly coupled to the drive belt at a respective fixed location on the drive belt.
A5. An assembly of paragraph A, wherein the positioning mechanism has an “H bot” configuration.
A6. An assembly of paragraph A including a top guide for engaging an upper surface of a food product.
A7. An assembly of paragraph A6, wherein the positioning mechanism is operable to move the top guide relative to the assembly support towards and away from the support plane.
A8. An assembly of paragraph A, wherein the positioning mechanism is operable to adjust a control force exerted on a food product by the side guides and/or the top guide of the assembly.
A9. An assembly of paragraph A8, wherein the positioning mechanism is operable to adjust the control force so that a maximum control force that can be exerted when the food product is moving towards a cutter of the food portioning machine is lower than a maximum control force that can be exerted during cutting of the food product.
B. A food portioning machine including a control assembly for guiding a food product along a flow path towards a cutter of a food portioning machine when the food product is supported on a support plane defined by the machine, comprising:
   an assembly support for mounting on the food portioning machine;
   a pair of side guides carried by the assembly support for engaging opposite side surfaces of a food product lying on the support plane; and
   a positioning mechanism which is carried by the assembly support and is operable:
   to move the side guides relative to the assembly support towards and away from the support plane; and
   to change the spacing between the side guides in a transverse direction with respect to the flow path.
B1. A machine of paragraph B, including a controller for controlling operation of the machine, wherein the controller is able to generate control signals which govern the maximum control force exerted on a food product by the side guides and/or the top guide of the assembly.
B2. A machine of paragraph B, wherein the control assembly is arranged to engage a food product when the food product is at a position adjacent to a cutter of the machine.
B3. A machine of paragraph B including a sensing region in which the shape of the food product is detected and a cutter for cutting the food product into portions, wherein the control assembly is arranged to guide a food product received directly from the sensing region towards and directly to the cutter.
C. A method of guiding a food product along a flow path towards a cutter of a food portioning machine when the food product is supported on a support plane defined by the machine using a control assembly for guiding a food product along a flow path towards a cutter of a food portioning machine when the food product is supported on a support plane defined by the machine, comprising:
   an assembly support for mounting on the food portioning machine;
   a pair of side guides carried by the assembly support for engaging opposite side surfaces of a food product lying on the support plane; and a positioning mechanism which is carried by the assembly support and is operable:
   to move the side guides relative to the assembly support towards and away from the support plane; and
   to change the spacing between the side guides in a transverse direction with respect to the flow path,
   the method comprising the step of:
   bringing the pair of side guides into engagement with opposite side surfaces of the food product lying on the support plane using the positioning mechanism.
C1. A method of paragraph C including the steps of:
   exerting a movement control force on the food product with the side guides as the food product moves along the flow path; and
   exerting a cutting control force on the food product with the side guides during cutting of the food product, with the cutting control force being greater than the movement control force.
C2. A method of paragraph C1, wherein the movement control force is less than or equal to a movement control force threshold, and the cutting control force is less than or equal to a cutting control force threshold, with the cutting control force threshold being greater than the movement control force threshold.
D. A method of restraining a food product moving along a flow path towards a cutter of a food portioning machine, comprising the steps of:
   exerting a movement control force on the food product as the food product moves along the flow path; and
   exerting a cutting control force on the food product during cutting of the food product, with the cutting control force being greater than the movement control force.
D1. A method of paragraph D, wherein the movement control force is less than or equal to a movement control force threshold, and the cutting control force is less than or equal to a cutting control force threshold, with the cutting control force threshold being greater than the movement control force threshold.
D2. A method of paragraph D, wherein the movement control force is exerted on the food product between each cut through the food product as the food product moves along the flow path in preparation for the next cut.
D3. A method of paragraph D, wherein the cutting control force is exerted at least at the start of each cut through the food product.
D4. A method of paragraph D, wherein a guide which exerts the movement control force is also used to exert the cutting control force on the food product.
D5. A method of claim D4, wherein the guide exerts the movement control force on the food product as it travels towards the cutter of the food portioning machine before a first cut has been carried out on the food product by the cutter.
D6. A method of claim D4, wherein the guide comprises a pair of side guides for engaging opposite sides of a food product lying on a support plane defined by the food portioning machine.
D7. A method of claim D4, wherein the magnitude of the force exerted by the guide is controlled by adjusting a pushing force exerted on the guide which urges the guide towards the food product.

1. A control assembly for guiding a food product along a flow path towards a cutter of a food portioning machine when the food product is supported on a support plane defined by the machine, comprising:
an assembly support for mounting on the food portioning machine;
a pair of side guides carried by the assembly support for engaging opposite side surfaces of a food product lying on the support plane; and
a positioning mechanism which is carried by the assembly support and is operable:
to move the side guides relative to the assembly support towards and away from the support plane; and
to change the spacing between the side guides in a transverse direction with respect to the flow path.

2. An assembly of claim 1, wherein the positioning mechanism is operable to selectively and/or simultaneously (a) move the side guides relative to the assembly support towards and away from the support plane and (b) change the spacing between the side guides in a transverse direction with respect to the flow path.

3. An assembly of claim 1, wherein the positioning mechanism is operable to move each side guide towards and away from the other at the same speed relative to the assembly support.

4. An assembly of claim 1, wherein the positioning mechanism includes a drive belt which is coupled to the side guides to move them relative to the assembly support.

5. An assembly of claim 4, wherein each side guide is rigidly coupled to the drive belt at a respective fixed location on the drive belt.

6. An assembly of claim 1, wherein the positioning mechanism has an “H bot” configuration.

7. An assembly of claim 1 including a top guide for engaging an upper surface of a food product.

8. An assembly of claim 7, wherein the positioning mechanism is operable to move the top guide relative to the assembly support towards and away from the support plane.

9. An assembly of claim 1, wherein the positioning mechanism is operable to adjust a control force exerted on a food product by the side guides and/or the top guide of the assembly.

10. An assembly of claim 9, wherein the positioning mechanism is operable to adjust the control force so that a maximum control force that can be exerted when the food product is moving towards a cutter of the food portioning machine is lower than a maximum control force that can be exerted during cutting of the food product.

11. A food portioning machine including the control assembly of claim 1.

12. A machine of claim 11 including a controller for controlling operation of the machine, wherein the controller is able to generate control signals which govern the maximum control force exerted on a food product by the side guides and/or the top guide of the assembly.

13. A machine of claim 11, wherein the control assembly is arranged to engage a food product when the food product is at a position adjacent to a cutter of the machine.

14. A machine of claim 11 including a sensing region in which the shape of the food product is detected and a cutter for cutting the food product into portions, wherein the control assembly is arranged to guide a food product received directly from the sensing region towards and directly to the cutter.

15. A method of guiding a food product along a flow path towards a cutter of a food portioning machine when the food product is supported on a support plane defined by the machine using a control assembly of claim 1, the method comprising the step of:
bringing the pair of side guides into engagement with opposite side surfaces of the food product lying on the support plane using the positioning mechanism.

16. A method of claim 15 including the steps of:
exerting a movement control force on the food product with the side guides as the food product moves along the flow path; and
exerting a cutting control force on the food product with the side guides during cutting of the food product, with the cutting control force being greater than the movement control force.

17. A method of restraining a food product moving along a flow path towards a cutter of a food portioning machine, comprising the steps of:
exerting a movement control force on the food product as the food product moves along the flow path; and
exerting a cutting control force on the food product during cutting of the food product, with the cutting control force being greater than the movement control force.

18. A method of claim 16, wherein the movement control force is less than or equal to a movement control force threshold, and the cutting control force is less than or equal to a cutting control force threshold, with the cutting control force threshold being greater than the movement control force threshold.

19. A method of claim 15, wherein the movement control force is exerted on the food product between each cut through the food product as the food product moves along the flow path in preparation for the next cut.

20. A method of claim 15, wherein the cutting control force is exerted at least at the start of each cut through the food product.

21. A method of claim 15, wherein a guide which exerts the movement control force is also used to exert the cutting control force on the food product.

22. A method of claim 21, wherein the guide exerts the movement control force on the food product as it travels towards the cutter of the food portioning machine before a first cut has been carried out on the food product by the cutter.

23. A method of claim 21, wherein the guide comprises a pair of side guides for engaging opposite sides of a food product lying on a support plane defined by the food portioning machine.

24. A method of claim 21, wherein the magnitude of the force exerted by the guide is controlled by adjusting a pushing force exerted on the guide which urges the guide towards the food product.

25. A method of claim 17, wherein a control assembly is controlled to exert the movement control force and the cutting control force on the food product wherein the control assembly is for guiding the food product along the flow path towards the cutter of the food portioning machine when the food product is supported on a support plate defined by the machine and comprises
an assembly support for mounting on the food portioning machine;
a pair of side guides carried by the assembly support for engaging opposite side surfaces of a food product lying on the support plane; and
a positioning mechanism which is carried by the assembly support and is operable:
to move the side guides relative to the assembly support towards and away from the support plane; and
to change the spacing between the side guides in a transverse direction with respect to the flow path.
